(19) United States
(12) Patent Application Publication
(10) Pub. No.: US 2008/0252722 A1
(43) Pub. Date: Oct. 16, 2008

(54) System And Method Of Intelligent Surveillance And Analysis

(76) Inventors: Yuan-Kai Wang, Hsinchuang (TW); Li-Ya Wang, Hsinchuang (TW); Yung-Hsiang Hu, Hsinchuang (TW)

Correspondence Address: LIN & ASSOCIATES INTELLECTUAL PROPERTY, INC., P.O. BOX 2339, SARATOGA, CA, 95070-0339, US

(21) Appl. No.: 11/733,766

(22) Filed: Apr. 11, 2007

(51) Int. Cl. H04N 7/18

(52) U.S. Cl. 348/143; 348/E07.085

(57) ABSTRACT

System and method of intelligent surveillance and analysis mainly used for monitoring whether a field has an intrusion object (such as a thief), and instantly providing video or image of the suspected intruder to approved relevant individual (such as the house owner) for further confirmation of the presence of the intrusion object (such as thief); therefore, the wrongful determination by the computer is avoided. The aforementioned system includes, first the determination and extraction of the contour of the suspected intrusion object, then the continuous tracking of the suspected intrusion object according to the contour, continue capturing of images using the camera, and then storing these captured video temporarily, and finally notifying the house owner using the highest definition image of the video which occupies a lesser amount of bandwidth through various communication channels once the presence of thief is determined; the video is downloaded using higher bandwidth, and is played.

### BACKGROUND OF THE INVENTION

1. Field of the Invention

The present invention relates generally to an intelligent surveillance system, and in particular to a method for video analysis and storage for conducting surveillance through the use of surveillance cameras.

2. The Prior Arts

Both the financial institutions and supermarkets, because of having massive amounts of cash on hand, frequently have installed cameras as a deterrent against possible criminal behaviors of potential robbers, and another reason is to provide information to law enforcement, which is helpful for capturing the robbers. However, a conventional camera is only capable of capturing images in a fixed position and at a fixed angle, and at the most, to capture images within a fixed designated viewing region. Thus, for a person who is keen on avoiding being captured on video, it may be difficult to capture a usable image that is intact.

To overcome this problem, the prior art “Storage and application apparatus based upon the technology of object tracking and recognition technique of image extraction” has been described, which utilizes a tracking method for monitoring and recording a particular selected field, and in particular to monitoring mobile objects (such as person).

To be capable of monitoring and recording a particular selected field under the tracking method, apart from the tracking technique itself, the device as described in the prior art “Tracking Camera Structure” is further needed. Having the camera as taught in the aforementioned patent, the corresponding camera lens is controlled to rotate vertically and horizontally, thus providing seamless image capturing without having dead angles.

Besides having the surveillance tracking, and if recognition monitoring were added also, it will become a more complete surveillance system. As described in the prior art “Method and apparatus for face photographing/recognition”, specific features may be used for identifying a person, so that specifically selected individuals are allowed or disallowed to enter the specific financial institutions and supermarkets. For example, in order to force people to take off their safety hats when entering a supermarket, the automatic door will not open upon the detection of people wearing safety hat.

Among surveillance techniques, besides the aforementioned applications such as tracking and recognition, remote monitoring should also be taken into consideration. Briefly, remote monitoring mainly transmit video captures from the camera to the monitoring host, and then to perform video data storage through the monitoring host, or to transmit the video to remote mobile devices through wireless network.

As described in the prior art “Active video monitoring system”, it mainly stores video images for a fixed time before and after the detection of the presence of intrusion object, and these images are provided for the user to obtain through the Internet.

In addition to the aforementioned network monitoring, GPRS, having higher mobility, could also be used to achieve remote monitoring. As described in the prior art “Monitoring camera device with General Packet Radio Service (GPRS)”, it mainly transmits image data of intrusion objects captured by the camera to mobile phones of users through GPRS; and the user transmits short messages of control commands through the Short Message Service (SMS) to control the surveillance camera. In this conventional technique, although the camera could be controlled using SMS, it is impossible for the user to watch the intrusion image at the same time while he or she is transmitting control commands to the camera through SMS, and as a result, the user could not achieve real time surveillance.

To resolve the problem of the inability to monitor in real time, the prior art “System and method for wireless network video surveillance” is provided; it mainly transmits video images of intrusion objects captured by the camera to network servers through the wireless network, so that the user could obtain surveillance video images by connecting to the network server through the Internet. In the meantime, the provided interface controlled surveillance camera is used to achieve real time monitoring.

Although remote monitoring through the Internet or 3G/GPRS has many conveniences and advantages, the available bandwidth of both the 3G and GPRS are still limited. If several fields are being monitored simultaneously, and these fields all happen to transmit their current images at the same time due to improper network traffic control, it is then most likely to cause line congestions. As a result, the line congestion could lead to the situation where no video or information could even be received. Even during sequential broadcasting of the aforementioned video images, for the sake of preventing not being able to receive any video or information due to congestion, there could be a case where the video containing an actual intrusion event is located near the end of the broadcast sequence; and accordingly, the video is displayed later than the normal video, and is watched by the user in sequence. And as a result, the intruder may have already disappeared from the scene when the intrusion event is eventually viewed upon.

To resolve the aforementioned problems of remote monitoring through Internet or 3G/GPRS, in which the bandwidth utilization should be reduced, the full bandwidth is used only when it is considered to be necessary (as when intruder is present) for achieving real time monitoring. In addition, features such as the aforementioned tracking, remote control camera, and face recognition are still used in the present invention for improving the performance capability of the surveillance system.

### SUMMARY OF THE INVENTION

A primary objective of the present invention is to provide a system and method of intelligent surveillance and analysis, which includes the pre-stored video or images of a suspected intruder to provide to an approved relevant individual (such as the house owner) to differentiate the presence of intrusion object or entities (such as a thief) during the preliminary assessment of suspected intruders, thus avoiding the unnecessary wrongful determination by the computer.

A secondary objective of the present invention is to provide a system and method of intelligent surveillance and analysis, which only transmit images of the corresponding fields occupying a lesser amount of bandwidth, so that the overall bandwidth loading could be reduced during the monitoring of a large number of fields. Later, the pre-stored video capture of the intruder is then played for further confirmation after the user has determined the presence of the suspected thief.

Based on these objectives, the system and method of intelligent surveillance and analysis according to the present invention comprises the following: first, the contour of a suspected intrusion object is determined and extracted; then the suspected intrusion object is tracked according to the contour and the image is to remain being captured through the use of the camera; and then the captured video is temporarily stored; finally, the house owner is notified using the highest definition image video (which occupies lesser amount of bandwidth) through various communication channels, upon the determination of the presence of the suspected thief; and then the video is downloaded using a higher bandwidth, and is to be played.

Additional advantages and spirit of the present invention may be realized and attained from the detailed description and appended drawings as follows.

### BRIEF DESCRIPTION OF THE DRAWINGS

The present invention will be apparent to those skilled in the art by reading the following detailed description of a preferred embodiment thereof, with reference to the attached drawings, in which:

FIG. 1A-FIG. 1B are a plurality of schematic block diagrams illustrating a transmitted high definition image in accordance with one embodiment of the present invention;

FIG. 2A-FIG. 2B are a plurality of schematic block diagrams illustrating a transmitted field video file in accordance with one embodiment of the present invention;

FIG. 3A-FIG. 3B are a plurality of schematic block diagrams illustrating a remote control method for controlling the direction of the camera in accordance with one embodiment of the present invention; and

FIG. 4A-FIG. 4B are a plurality of schematic diagrams illustrating a remote control method for image centering in accordance with one embodiment of the present invention.

### DETAILED DESCRIPTION OF THE PREFERRED EMBODIMENT

The system and method of intelligent surveillance and analysis according to the present invention, mainly comprises three parts, namely, the transmitting of high definition image (including images of the intruder), the transmitting of the field video file (including video containing the intruder), remote controlling of the direction of the camera; the procedures of which will be described in detail as follows.

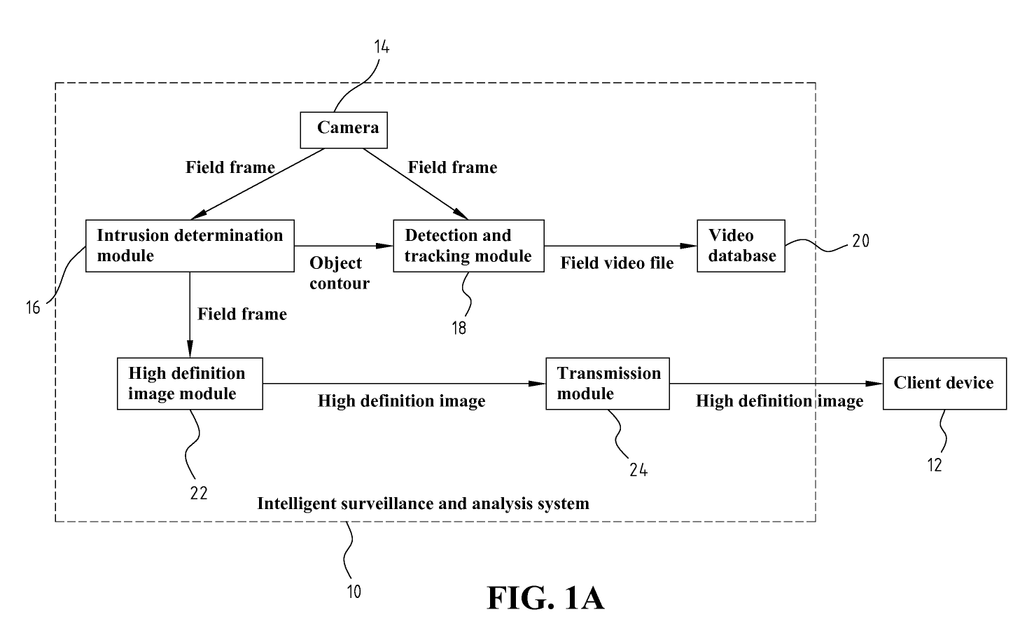

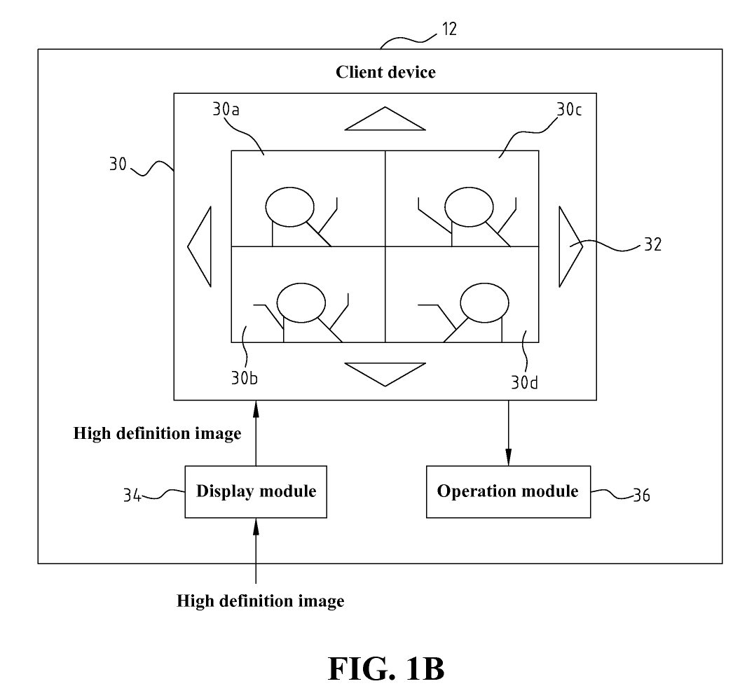

Referring to FIG. 1A-FIG. 1B, a plurality of schematic block diagrams illustrating a high definition image in accordance with one embodiment of the present invention are shown. As shown in FIG. 1A, the intelligent surveillance and analysis system 10 mainly comprises a camera 14, an intrusion determination module 16, a detection and tracking module 18, an image database 20, a high definition image module 22, and a transmission module 24. And in this embodiment, the corresponding high definition image is transmitted to the client device 12 upon the detection of suspicious intrusion object. The system 10 further comprises the camera 14 to capture the predetermined field to obtain continuously captured frames. In the case where multiple surveillance fields are required, a corresponding camera 14 is installed in every field.

Briefly speaking, in this embodiment, the intelligent surveillance and analysis system 10 comprises: the determination of the presence of the intrusion object (such as a thief); the contour of the suspected intrusion object is extracted if the intrusion object is initially determined to be present; when the detection and tracking module 18 receives the contour of the object, the detection and tracking module 18 can maintain tracking of the object according to the contour and to maintain video capturing by using the camera 14, and to store the captured video to the video database 20 temporarily; finally, the highest definition image (occupying a lesser amount of bandwidth such as a JPEG file) is selected and transmitted by the high definition image module 22 from the aforementioned video to the client device 12 (such as a house owner) through various possible communication channels, such as Internet, 3G/GPRS, fax, and so on.

When capturing the contour of suspected intrusion object, the intrusion determination module 16 will first obtain the image of the suspected object using image subtraction (such as subtracting the empty field image) and image binarization technique, and then remove the image noise using morphology techniques, and obtain the contour of the aforementioned object using CCL (Connected Component labeling) and MBR (minimum boundary rectangle).

The detection and tracking system module 18 controls the capturing operation of the camera 14. When the intrusion object is found inside the field frame, the detection and tracking system module 18 begins to store the field frames which are related to the intrusion object as the field video file until the time when no intrusion object is found inside the field frame.

The high definition image module 22 is used for seeking out the field frames with the maximum ratio of the contour of the object to the field frame and/or the field frames with the contour of the object corresponding to the field frames containing the recognizable face data mainly by using object segmentation, feature extraction, feature analysis, and other programs etc; and the corresponding field frame is defined as the high definition image. Using a person as an example, information such as the face and height of the person should be easily obtainable from the high definition image (or key image frame). Thus, the aforementioned image then belongs to a high definition image, and it would be adequate to allow the house owner to determine whether the object or entity is a thief or not. Taking an automobile as an example, an image could be classified as a high definition image only when it includes the image of the automobile number plate. Moreover, another function of the high definition image module 22 is to show every portion of the object clearly. Using a person as an example, the head, hand, body, feet etc. of the person, as well as the patterns on the clothing as shown on the back of the person should appear in the key image frames; using an automobile as an example, the front and rear images of the automobile, including the shape of the automobile lighting, the styling of the hood of the automobile, and the manufacturer emblem at the back etc., which all should be included in the image for assisting to set up the automotive search data when performing the manual or automatic image analysis method. Since the front and rear of a person or an automobile cannot appear both in one image simultaneously, the number of key high definition images may be more than one image. In theory, the definition of the object is affected by three factors: namely, the camera, the environment, and the object. Resolution of the camera, the diaphragm, and focal adjustments will affect the resolution of the object. Whether the brightness of the surroundings is enough, as well as, whether if there are background barrier covering the object may also affect the resolution of the object. In additional, the resolution may also be affected by the object's own moving speed, posture and positioning in relation to the camera.

In order to achieve the object of high definition image extraction, feature analysis should be performed on each image of the video. The feature analysis includes object fuzzy degree analysis, object color analysis, object texture analysis, object shape analysis, object dynamic analysis, and object front and back analysis. The object fuzzy degree analysis is able to extract the edge or high frequency information of the object image using Edge Detection or High-pass Filter technique for analyzing the degree of fuzziness of the object. Object texture analysis, which is useful for extracting patterns from the object, may be conducted using High-pass Filter or Markov Random Field technique. Object color analysis using the Clustering or Gaussian Mixture Models method may be conducted according to the color distribution status in the color space for extracting the color information, such as skin color information. Object shape analysis used for analyzing the object shape information such as length, width, axis, axle base, area, contour, etc, may be achieved using general statistical method or the Active Contour method. Object dynamic analysis, which is useful for determining the moving direction of the object, may be achieved using the Block Matching and the Optical Flow method. Object front and back analysis may be achieved by face recognition, automobile number plate detection, and the dynamic analysis of the moving direction, etc.

Many features of the object are obtained according to the above six analysis methods, and are maximized using the expectation function to select the key frame, as described in the following equation:

$$Keyframes = arg {max}_{i} O ( {f}_{1} , {f}_{2} , {f}_{3} , {f}_{4} , {f}_{5} , {f}_{6} \vert {Frame}_{i} )$$

in which f₁ is a group of quantization values obtained from object fuzzy degree analysis, f₂ is a group of quantization feature values obtained from object color analysis, f₃ is a group of quantization feature values obtained from object texture analysis, f₄ is a group of quantization feature values obtained from object shape analysis, f₅ is a group of quantization feature values obtained from object dynamic analysis, and f₆ is a group of quantization feature values obtained from object front and back analysis; Frameᵢ represents a plurality of images; O(f|Frameᵢ) represents the extracted feature from the images, and then a score is calculated relating to the degree of correspondence to the expectancy value of these images. Arg max signifies the selection of the images having the higher values as the key frames. The above expectation function O( ) may be calculated using the common linear weighted method:

O(f₁,f₂,f₃,f₄,f₅,f₆|Frameᵢ)=w₁f₁+w₂f₂+w₃f₃+w₄f₄+w₅f₅+w₆f₆

in which the feature with the higher weighted value signifies that it is more important in regards to the resolution of the image. The equation also may be further extended, not only that a group of quantization feature values may have a weight value, but also each feature value may have a corresponding weight value:

O(f₁, [symbol] ,fk|Frameᵢ)=w₁f₁+ [symbol] +wₖfₖ

in which f₁ . . . fₖ are k quantization feature values obtained from all six object analysis methods.

By means of the above steps such as feature analysis and maximization of expectation value, the extraction of the highest definition image is accomplished. Moreover, sometimes when it is required to perform higher detailed feature analysis for extracting higher-detailed high definition image of objects, object segmentation method may be used, and process feature analysis and resolution calculation for each segmented portion are performed. Using a person as an example, portions such as the head, hand, body, and foot may be segmented; and the feature of each portion is analyzed, such as whether the person is baldheaded, or whether the person is wearing a hat, and so on. Skin detection method may be used for calculating the color information of the segmented head portion; thus, the feature of the head is obtained and may be used as a feature value of the high definition image function. Taking an automobile for example, the portion of the hood, head light, tail end, boot, etc may be segmented, and the degree of fuzziness of each portion is analyzed; thus, the image resolution obtained from the analysis may be more precise than using only the degree of fuzziness of the entire image.

As shown in FIG. 1B, if there are several fields needing to be monitored in the system according to the present invention, the above-mentioned high definition images can all be transmitted to the client device 12 by means of the camera 14 installed in each field. The client device 12 segments the image displayed on the display 30 through the display module 34 into a plurality of corresponding blocks 30a-30d, so that the high definition images from various different fields are presented simultaneously.

As a result, in addition to using videos or images pre-stored by a video database 20 of a suspected intruder to provide to an approved relevant individual (such as the house owner) for differentiating and determining the presence of intrusion object (such as a thief), and avoiding the panic caused by the wrongful determination by computer, even when a large number of fields need to be monitored, the corresponding image (occupying lesser amount of bandwidth) of every field is first only transmitted; and after the user has verified the suspicion of having intruders, the video of the suspected intruder which is pre-stored in the video database 20 is then broadcasted to allow for further confirmation. Accordingly, not only the bandwidth loading can be reduced, but also, several fields can be monitored simultaneously.

Before describing how the video of the intruder pre-stored in the video database 20 is broadcasted, the method for signal transmission of the above-mentioned system will be described first. Internet or analog cable (wire or wireless) which is capable of transmitting over relatively long distances may be used between the camera 14 of each field and the intrusion determination module 16 and/or the detection and tracking system module 18, while there may be a different communication channel between the transmission module 24 and the client device 12 in accordance to the different types of the client device 12. In the case where the client device 12 is a mobile phone (such as GSM, CDMA, WCDMA mobile phone) which supports GPRS or 3G, the communication channel is over GPRS or 3G network; accordingly, the transmission module 24 may adopt the MMS (Multimedia Messaging Server) method for transmitting the high definition image. In the case where the client device 12 is a computer device which supports the Internet protocol and the web browser, the communication channel is Internet; thus, the high definition image may be transmitted using the TCP/IP protocol.

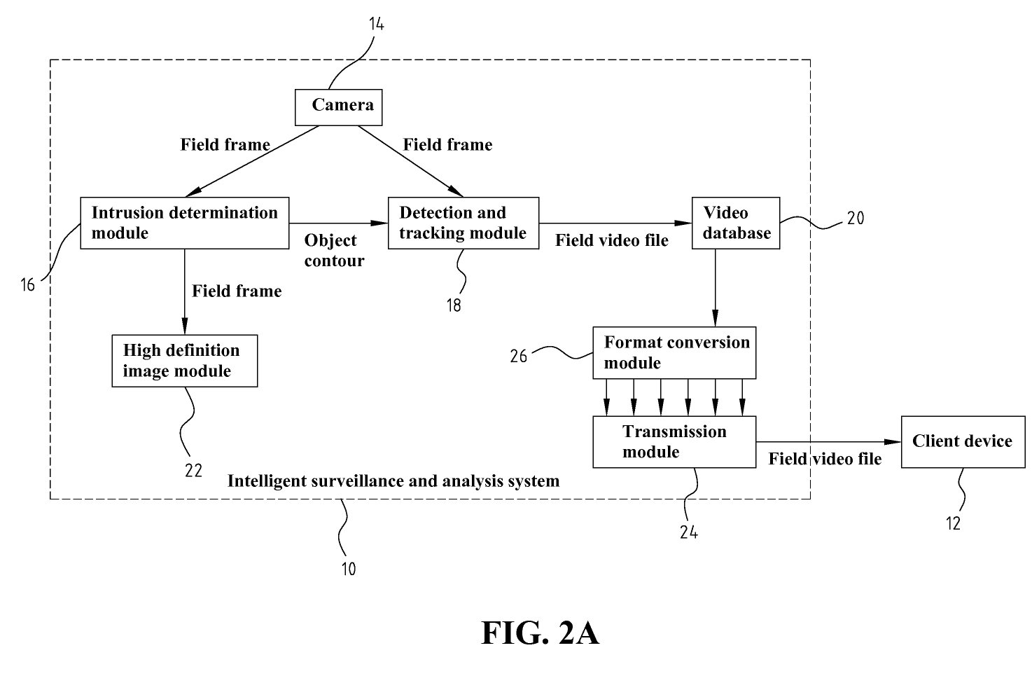

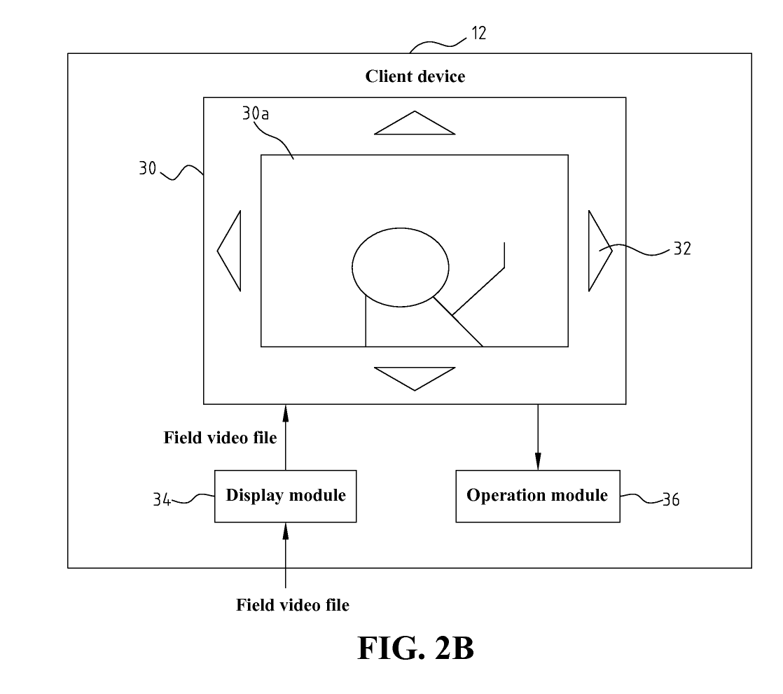

However, regardless as to how the high definition image is transmitted by whichever form of communication channel or method, the intrusion information (such as “System found suspected intruder, please watch out!”) is capable of being transmitted simultaneously; and the Uniform Resource Locator (URL) of the field video file corresponding to the high definition image and/or the field video file itself are also appended, so that the user may selectively play the field video file from the display 30 as shown in FIG. 1B. It is to be noticed that if the field video file itself is required to be transmitted directly, the file should be first converted to a format which can be supported by the client device 12 using the format conversion module 26 as shown in FIG. 2B.

Also referring to FIG. 2A-FIG. 2B, a plurality of schematic block diagrams illustrating a field video file in accordance with one embodiment of the present invention is shown. As shown in FIG. 2A, the intelligent surveillance and analysis system 10 in accordance with one embodiment of the present invention mainly comprises a camera 14, an intrusion determination module 16, a detection and tracking module 18, a video database 20, a high definition image module 22, and a transmission module 24, and further comprises a format conversion module 26.

After when the user selects the block 30a located at the top left corner from the displayed image as shown in FIG. 1B, the format conversion module 26 in the intelligent surveillance and analysis system 10 converts the field video file corresponding to the block 30a to various formats, such as 3GPP (Third-Generation Partnership Program), 3GPP2 (Third-Generation Partnership Program 2), and OMA (Open Mobile Alliance) for providing the converted video file to the transmission module 24 to be transmitted to the corresponding client device 12, as shown in FIG. 2B.

If the format conversion module 26 is only started to convert the format after the user has finished selecting a block, a problem would be created such that the user needs to wait for an extended period in order to be able to watch the recorded video. Therefore, another method is, after the detection and tracking system module 18 and the high definition image module 22 have performed the tracking of video recording and the providing of high definition image, respectively, the format conversion module 26 immediately converts the frame comprising the object to a video file, and stores the file. As a result, a user may watch the recorded video clip comprising the object, which has been converted and stored, on demand after he or she selects the block 30a.

In the case that the client device 12 is a mobile phone, the transmission module 24 transmits the field video file to the corresponding client device 12 using a format such as 3GP and MP4, which are compliant with the video streaming signal protocol for mobile phones. In the case that the client device 12 is a computer device, the transmission module 24 transmits the video file using format such as Windows Media Audio (WMA).

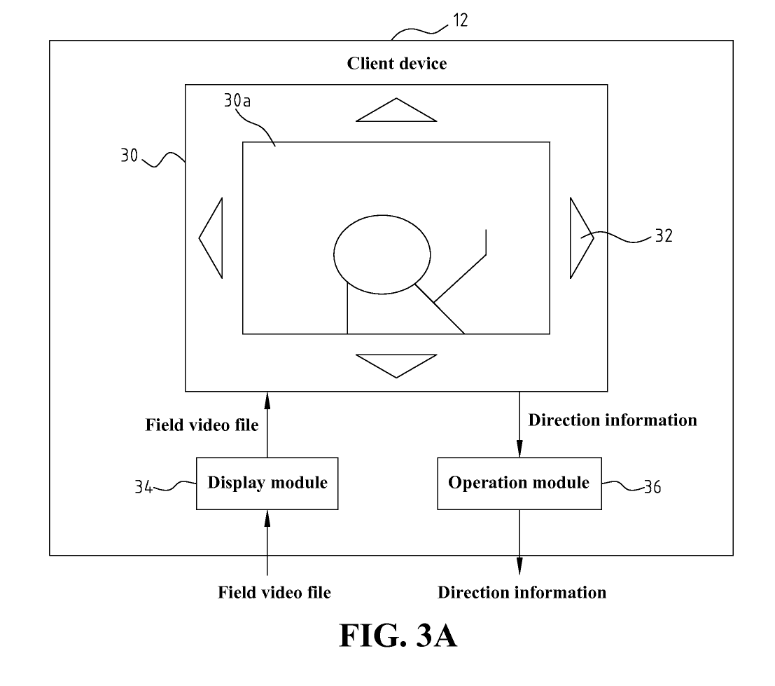

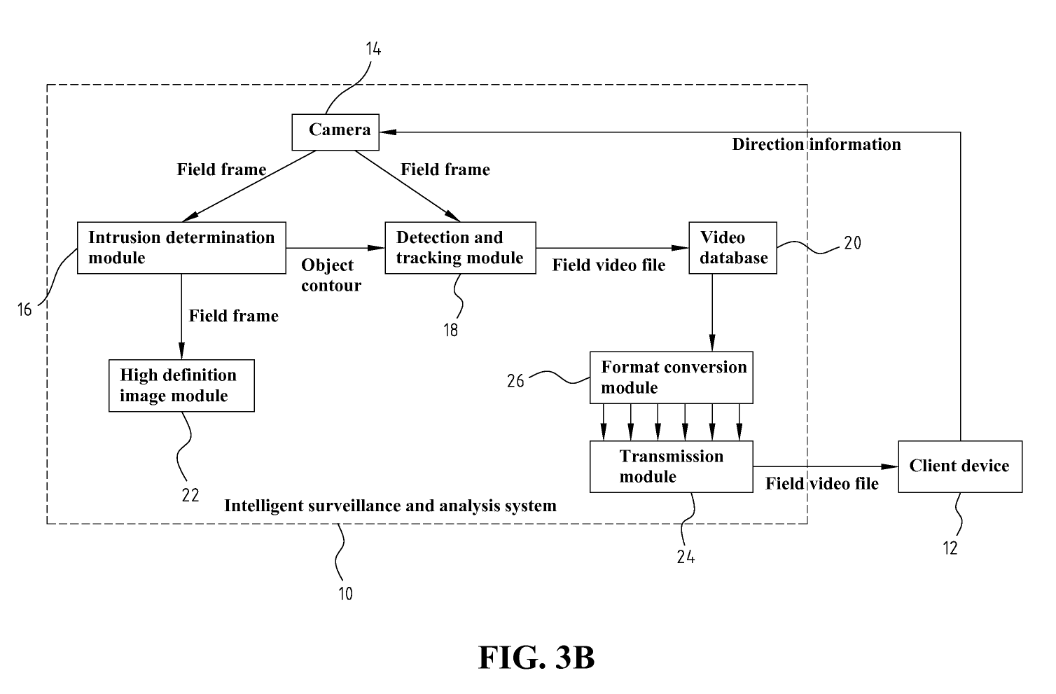

Also referring to FIG. 3A-FIG. 3B, FIG. 3A-FIG. 3B are a plurality of schematic block diagrams showing a remote control method for controlling the direction of the camera in accordance with one embodiment of the present invention. As shown in FIG. 3B, the intelligent surveillance and analysis system 10 mainly comprises a camera 14, an intrusion determination module 16, a detection and tracking module 18, a video database 20, a high definition image module 22, a transmission module 24, and a format conversion module 26.

In order to give the user further information concerning the present status relating to the field through the client device 12, the user may remotely control the camera 14 by pressing the button on an operation interface 32. For example, when the user is sending the direction information to move to the right through the operation interface 32, the operation module 36 then transmits the direction information to the camera 14. Thus, the camera 14 pans and/or tilts to the camera position corresponding to the direction information for shooting video of the field.

Furthermore, when the intrusion determination module 16 has determined the corresponding field frame to include the intrusion object, and then provides the contour of the intrusion object to the detection and tracking system module 18, the detection and tracking system module 18 may control the camera 14, which is capable to pan and tilt up, down, left, and right, to automatically focus on the center of the intrusion object for shooting video, thereby obtaining the most complete image.

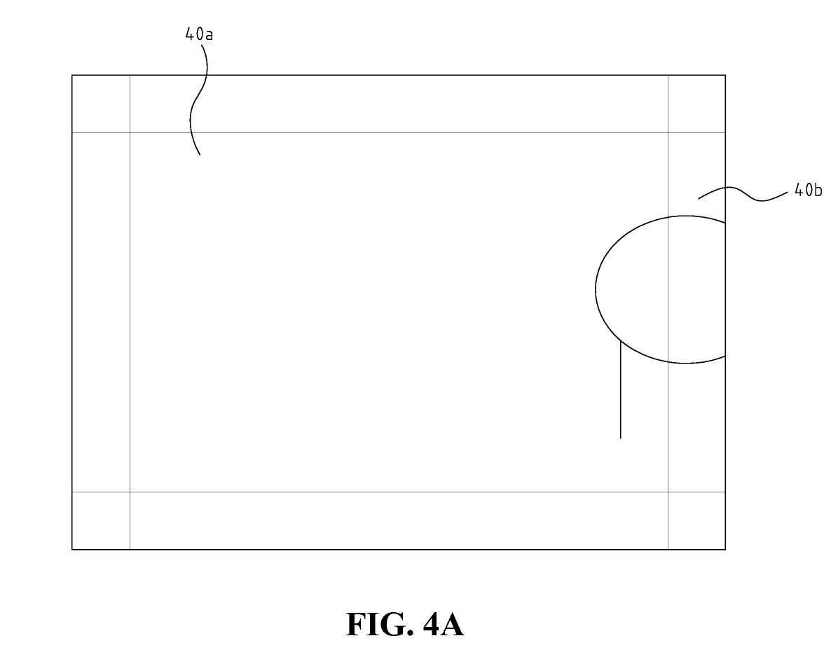

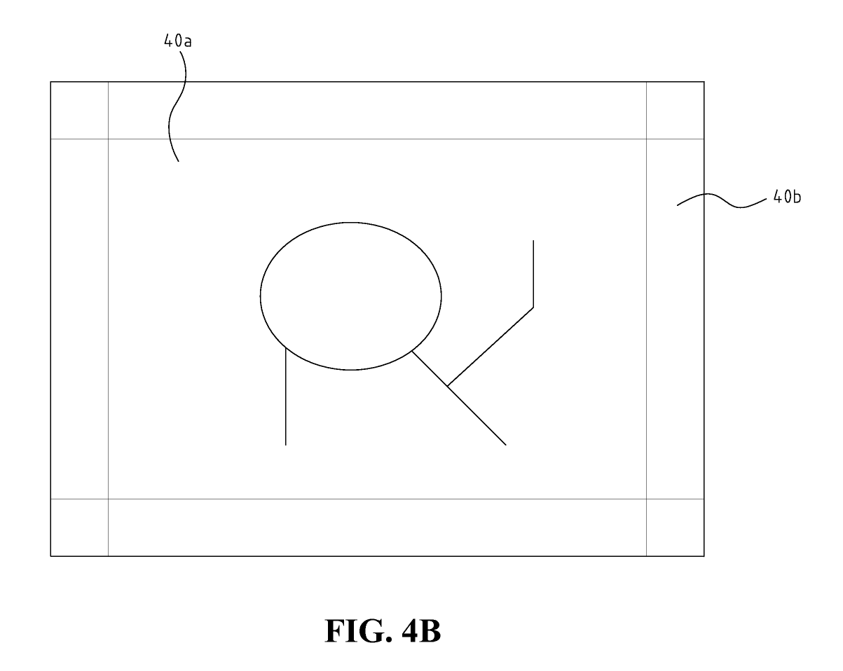

Also referring to FIG. 4A-FIG. 4B, FIG. 4A-FIG. 4B are the schematic diagrams showing a remote control method for image centering in accordance with one embodiment of the present invention. As shown in FIG. 4A, the intrusion determination module 16 divides the received field frame into nine control sections; and the control section located at the center is called center control section 40a. For example, in the case that the intrusion object travels across only the control section 40a and the control section 40b, and the center of the intrusion object is located in the control section 40b, the camera 14 may automatically pan towards the right to make the center of the intrusion object to be located in the control section 40a. In the case that the center of the intrusion object is located in the control section 40a, no control signal will be sent to the camera 14, and the camera 14 maintains the same as in the original state. Thus, the camera 14 is capable of automatically tracking the intrusion object, and keeping the intrusion object within the surveillance image of the camera 14 until the intrusion object is moved beyond the surveillance limit of the camera 14.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An intelligent surveillance and analysis system for monitoring a field, comprising:
a camera, capturing images inside the field and obtaining a plurality of continuously captured field frames;
an intrusion determination module, determining the presence of an intrusion object from the field frames, and extracting a contour of the intrusion object from the corresponding field frames;
a detection and tracking system module, determining the corresponding field frames wherein including the intrusion object, as the intrusion determination module has provided the contour of the intrusion object, and starting to store the field frames wherein including the intrusion object;
a high definition image module, seeking out the field frame with the maximum ratio of the contour of the object to the field frame or the field frame comprising the contour of the object corresponding to the field frames wherein comprising a plurality of recognizable face data of persons from the field frames wherein including the intrusion object, and defining the corresponding field frame as a high definition image; and
a transmission module, transmitting the high definition image, an URL address of a field video file, and the field video file itself to a client device.

2. The intelligent surveillance and analysis system as claimed in claim 1, wherein the detection and tracking system module beginning to store the field frames related to the intrusion object as the field video file upon determining of the intrusion object to be present in the field frame, and until the time wherein no intrusion object is found in the field frame.

3. The intelligent surveillance and analysis system as claimed in claim 1, wherein both the format of the high definition image and the field video file are corresponded to the format supported by the client device.

4. The intelligent surveillance and analysis system as claimed in claim 1, wherein the client device is a mobile phone supporting GPRS or 3G network, or a computer device supporting Internet and web browser.

5. The intelligent surveillance and analysis system as claimed in claim 1, wherein the client device further comprising:
a display module, displaying the high definition image and the field video file through the display; and
an operation module, providing an operation interface for receiving a direction information indicated from an user, and controlling the camera to pan and tilt to the camera position corresponding to the direction information for shooting video of the field.

6. The intelligent surveillance and analysis system as claimed in claim 5, wherein after the client device has received the high definition image, the URL address, and the field video itself wherein transmitted from the transmission module, the display module transmitting the field video file using the streaming packet format according to the URL address of the field video file and displaying the field video file through the display, when the user is desired to play the field video file.

7. The intelligent surveillance and analysis system as claimed in claim 1, wherein the detection and tracking system module controlling the camera to focus on the center of the intrusion object after the intrusion determination module has determined the corresponding field frame comprising the intrusion object and provided the contour of the intrusion object to the detection and tracking system module.

8. An intelligent surveillance and analysis method for monitoring a field, comprising:
capturing video of the field to obtain a plurality of continuously captured field frames;
seeking out an intrusion object from the field frames;
extracting a contour of the intrusion object from the corresponding field frames;
beginning to store the field frames wherein comprising the intrusion object upon determining of the intrusion object to be present in the field frame;
seeking out the field frame with the maximum ratio of the contour of the object to the field frame or the field frame comprising the contour of the object corresponding to a plurality of recognizable faces of persons from the field frames wherein comprising the intrusion object, and defining the corresponding field frame as the high definition image; and
transmitting the high definition image, an URL address of the field video file, and the field video file itself to a client device.

9. The intelligent surveillance and analysis method as claimed in claim 8, wherein upon determining of the intrusion object to be present in the field frame, storing the field frames relating to the intrusion object as a field video file until the time wherein no intrusion object is found in the field frame.

10. The intelligent surveillance and analysis method as claimed in claim 8, wherein both the format of the high definition image and the field video file are corresponded to the format supported by the client device.

11. The intelligent surveillance and analysis method as claimed in claim 8, wherein the client device is a mobile phone supporting GPRS or 3G network, or a computer device supporting Internet and web browser.

12. The intelligent surveillance and analysis method as claimed in claim 8, wherein the client device further comprises:
a display module, displaying the high definition image and the field video file through the display; and
an operation module, providing an operation interface for receiving a direction information indicated from an user, and controlling the camera to pan and tilt to the camera position corresponding to the direction information for shooting a video of the field.

13. The intelligent surveillance and analysis method as claimed in claim 12, wherein after the client device has received the high definition image, the URL address, and the field video itself wherein transmitted from the transmission module, transmitting the field video file by the display module using the streaming packet format according to the URL address of the field video file, and displaying the field video file through the display, when the user desires to play the field video file.

14. The intelligent surveillance and analysis method as claimed in claim 8, wherein controlling the camera to focus on the center of the intrusion object upon determining of the presence of the intrusion object in the field frame.
